(19) United States
(12) Patent Application Publication
(10) Pub. No.: US 2016/0331186 A1
(43) Pub. Date: Nov. 17, 2016

(54) APPARATUS AND METHOD FOR QUICKLY ASSEMBLING AND DELIVERING MEALS

(71) Applicant: Bento Technology, Inc., San Francisco, CA (US)

(72) Inventors: Javier de la Fuente, San Francisco, CA (US); Jason Demant, San Francisco, CA (US)

(21) Appl. No.: 15/041,997

(22) Filed: Feb. 11, 2016

Related U.S. Application Data
(60) Provisional application No. 62/127,042, filed on Mar. 2, 2015.

(51) Int. Cl. A47J 47/02; B65B 7/28; G06Q 50/12; B65D 43/02; G06Q 10/08; A47J 47/14; B65B 5/04

(52) U.S. Cl. CPC A47J 47/02; A47J 47/14; B65B 7/2842; B65B 5/04; B65D 43/0204; G06Q 10/083; G06Q 50/12

(57) ABSTRACT

An Apparatus and method for quickly assembling and delivering a meal by a driver, comprising: a meal container with a first and second interior cavities, a meal lid with two lid openings and a first and second food pod with food lids. The food pods are inserted in the interior cavities and the meal lid is placed onto the meal container, wherein the food lids mates with the lid openings through their protrusion. The meal lid is engaged to the food lids placed onto the food pods and such that the subsequent removal of the meal lid from the meal container automatically removes the food lids from the food pods, thereby delivering the meal to the consumer.

### TECHNICAL FIELD

This invention relates generally to the meal assembly and delivery field, and more specifically to a new and useful apparatus and method for quickly assembling and delivering meals.

### BACKGROUND

Food delivery is a fundamental solution for busy modern schedules. By ordering food delivery, a customer can access a nutritious meal without spending any time shopping for ingredients, cooking or cleaning afterwards. Currently, however, food delivery services often do not meet the speed expectations of increasingly fast-paced customers; and by time the food arrives to destination, the customer may be overly hungry and upset. Furthermore, meals usually arrive in a messy state, frustrating the customer who intended to eat rightly without mixing flavors or cleaning her dining space after consumption. The ability to effectively deliver a complete meal in a quick and neat manner can be a significant advantage in improving food delivery services.

Thus, there is a need in the food delivery field to create an improved meal box and method for food delivery. This invention provides such improved meal box and method.

### BRIEF DESCRIPTION OF THE FIGURES

FIG. 1 is a front elevation view of a first preferred embodiment of the invention;

FIG. 2 is a exploded perspective view of FIG. 1;

FIG. 3 is a perspective view of an alternative embodiment of the invention.

FIG. 4 a schematic representation of a first preferred embodiment of the invention;

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Apparatus

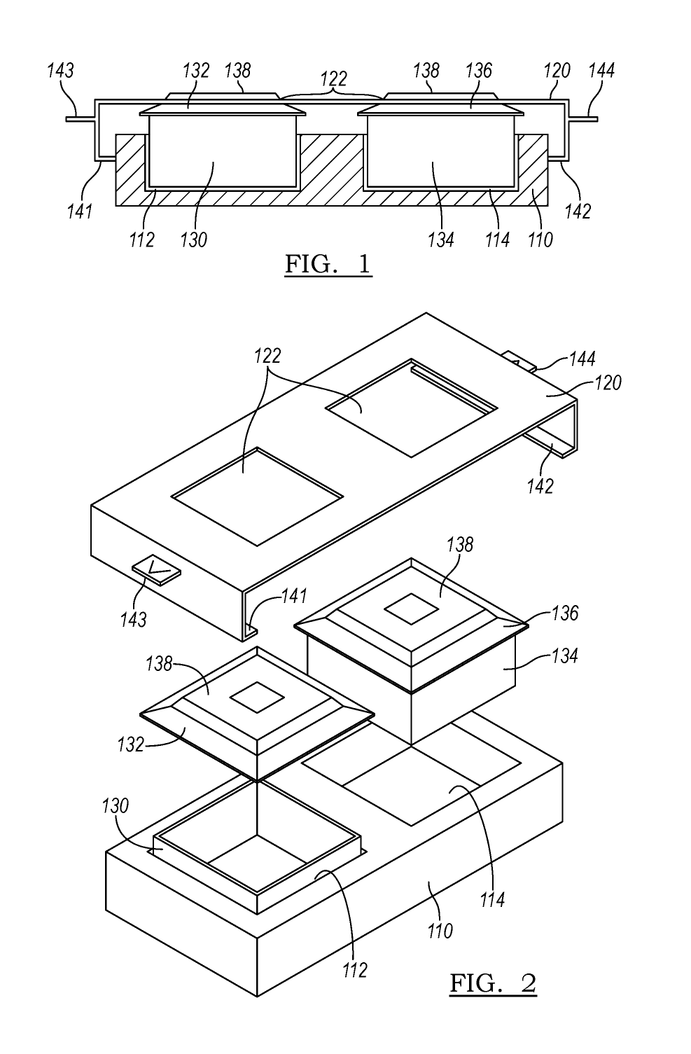

As shown in FIG. 1-2, the apparatus 100 of the preferred embodiment comprises a meal container 110 with a first and second interior cavity 112 and 114, a meal lid 120 that mates to the meal container 110 with at least two lid openings 122, and a first and second food pod 130 and 134 with a first and a second food lid 132 and 136. Furthermore, the first food lid 132 corresponds to the first food pod 130, which in turn corresponds to the first interior cavity 112. Likewise, the second food lid 136 corresponds to the second food pod 134, which in turn corresponds to the second interior cavity 114. Finally, the first and second food lid 132 and 136 have a protrusion 138 that mates with the lid openings 122 when the meal lid 120 is placed onto the meal container 110. Consequently, the meal lid 120 is engaged to the food lids 132 and 136 that are placed onto the food pods 130 and 134, and such that the subsequent removal of the meal lid 120 from the meal container no automatically removes the food lids 132 and 136 from the food pods 130 and 134.

The apparatus 100 is preferably designed for a driver to quickly assemble and delivering meals to consumers based on what they have ordered or requested. The apparatus 100 is alternatively designed for quickly assembling the meal at the restaurant or meal provider's location.

The meal container 110 functions as the structural base of the apparatus 100, by carrying the food pods 130 and 134 and supporting the meal lid 120 that closes it. The meal container no is preferable made from F-Flute corrugate, but alternatively can be made from a group of materials consisting of corrugated cardboard, corrugated fiberboard, corrugated paper, paper fiber, solid bleach board, paper board, bagasse and combinations thereof. The meal container 110 has preferably the shape of a rectangle, but alternatively it may have the shape from a group consisting of circle, triangle and any other suitable geometric shape. The meal container 110 can be used as a tray for the consumption of the meal directly from it, without the need of removing the food pods 130 and 134 from the meal container 110. This last use helps in saving space for the consumer during the consumption of the meal.

The interior cavities 112 and 114 functions to hold the food pods 130 and 134 to the meal container 110 during the delivery by the driver and once the meal lid 120 is removed from the meal container 110 and the food lids 132 and 136 are removed from the food pods 130 and 134. They have preferably the shape of a cube but alternatively they may have the shape of any other suitable geometric shape.

The meal lid 120 functions to close the meal container 110 once placed onto it, to secure the food pods 130 and 134 and to remove the food lids 132 and 136 once it is removed from the meal container 110. The meal lid 120 is preferable made from F-Flute corrugate, but alternatively can be made from a group of materials consisting of corrugated cardboard, corrugated fiberboard, corrugated paper, paper fiber, solid bleach board, paper board, bagasse and a combination thereof. The meal lid 120 has preferably the shape of a rectangle, but alternatively it may have the shape from a group consisting of a circle, triangle or any other suitable geometric shape.

The lid openings 122 functions to engage with the protrusion 138 of the food lids 132 and 136, by placing the meal lid 120 onto the meal container 110. This automatically removes the food lids 132 and 136 from the food pods 130 and 134 once the meal lid 120 is removed from the meal container 110. The lid openings 122 have preferably the shape of a square but alternatively it may have the shape from a group consisting of a circle, triangle, any other suitable geometric shape or combinations thereof.

The food pods 130 and 134 functions to contain preferably a solid or liquid food but alternatively may contain drinks and/or a solid or liquid condiment. In the prefer embodiment one of the food pods 130 and 134 is a side order (e.g. rice, vegetables or noodles) and the other is a main order e.g. (fish, meat or poultry). Both food pods 130 and 134 are inserted into the interior cavities 112 and 114 of the meal container 110 to constitute the meal assembled and delivered to consumers. The food pod for the side order has a capacity to contain up to 5 ounces of food while the one for the main order has a capacity of 8 to 10 ounces of food. The food pods 130 and 134 are preferable made from F-Flute corrugate, but alternatively can be made from a group of materials consisting of corrugated cardboard, corrugated fiberboard, corrugated paper, paper fiber, solid bleach board, paper board, bagasse and a combination thereof. The food pods 130 and 134 have preferably the shape of a cube but alternatively it may have the shape any other suitable geometric shape. Additionally, the food pods 130 and 134 can be used as a recipient for heating the food contained in them in a microwave or conventional oven with no substantial damage to their material.

The food lids 132 and 136 functions to close or seal the food pods 130 and 134 so that the food contained in the food pods 130 and 134 is not spilled during the delivery process; is not in contact with external environment, conditions or objects or is not directly manipulated by the driver; to keep the temperature of the food contained in the food pods 130 and 134; and to engage with the lid openings 122 of the meal lid 120 by their protrusion 138 so when the meal lid 120 is removed from the meal container 110, it automatically removes the food lids 132 and 136 from the food pods 130 and 134. The food lids 132 and 136 are preferable made from polypropylene but alternatively can be made from a group of materials consisting of polystyrene, polyvinyl chloride, recycled polyethylene terephthalate, polylactic acid and other rigid polymers. The food lids 132 and 136 have preferably the shape of a square but alternatively it may have the shape from a group consisting of a circle, triangle, any other suitable geometric shape and combinations thereof. The act of placing the food lids 132 and 136 onto the food pods 130 and 134 is preferably done by the restaurant or meal provider to further ensure the hygiene of the meal, but alternatively may be placed onto the food pods 130 and 134 by the driver.

As shown in FIG. 1-2, in the apparatus 100 further comprises a first and a second flap 141 and 142 both defined in the meal lid 120. The first flap 141 is defined at one side of the meal lid 120 and the second flap 142 defined at an opposite side of the first flap 141 in the meal lid 120. The apparatus 100 also comprises a first and a second tab 143 and 144 defined in the flaps 141 and 142 of the meal lid. The first tab 143 is defined from the first flap 141 and the second tab 144 is defined from the second flap 142.

The flaps 141 and 142 in the meal lid 120 functions as hooks to engage with the sides of the meal container 110 for mating and further securing the meal lid 120 to the meal container 110. The hooks are formed by pushing the flaps 141 and 142 to the meal lid 120 in an inwards position. This also makes the first tab 143 and second tab 144 prominent, especially when pulled out from the flaps 141 and 142. The flaps 141 and 142 are made of the same material as the meal lid 120.

The tabs 143 and 144 functions as a removing or disengaging mechanism of the hooks that are formed from the flaps 141 and 142 that are engaged to the sides of the meal container 110; of the meal lid 120 from the meal container 110; and the food lids 132 and 136 from the food pods 130 and 134 previously inserted in the meal container 110. The tabs are made of the same material as the meal lid 120.

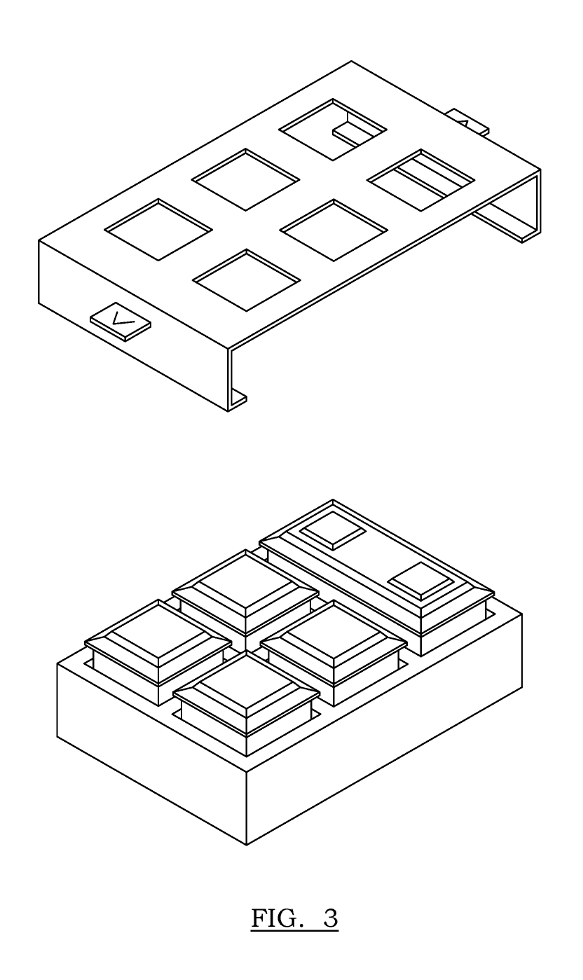

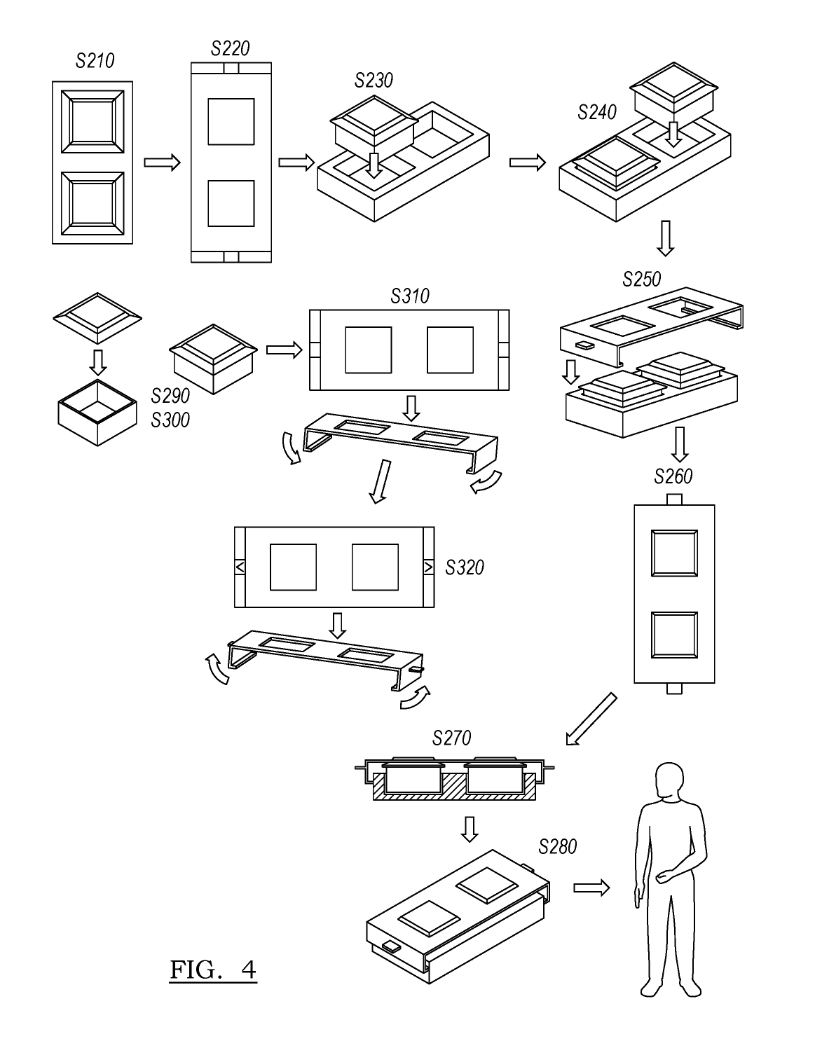

As shown in FIG. 3, in an alternative embodiment the apparatus 100 may comprise the meal container defining more than two interior cavities, the meal lid defining more than two lid openings and more than two food pods with more than two food lids. The function of each of these elements is identical to ones of the preferred embodiment. In this alternative embodiment, there can be more than one side order (e.g. rice, vegetables or noodles) or more than one main order e.g. (fish, meat or poultry) as part of the meal quickly assembled and delivered by the driver.

### 2. Method

As shown in FIG. 4, the preferred method 200 for quickly assembling and delivering meals by a driver preferably comprises: Folding a meal container defining a first interior cavity and a second interior cavity S210; Folding a meal lid mating with the meal container, the meal lid defines at least two lid openings S220; Inserting the first food pod with the first food lid into the first interior cavity of the meal container S230; Inserting the second food pod with the second food lid into the second interior cavity of the meal container S240; Placing the meal lid onto the meal container S250; Mating the food lids by their defined protrusion to the lid openings of the meal lid S260; Engaging the meal lid to the food lids and such that when the meal lid is subsequently removed from the meal container, the food lids are automatically removed from the food pods S270; and delivering the meal to the consumer S280.

The method 200 can further comprise: placing a first food lid unto a first food pod, wherein the first food lid corresponds to the first food pod S290; placing a second food lid unto a second food pod, wherein the second food lid corresponds to the second food pod S300; Pushing two flaps defined in the meal lid, the first flap defined at one side of the meal lid and the second flap defined at an opposite side of the first flap in the meal lid to further defining a first and second hook to aid in the engaging with the meal container S310 and; pulling out two tabs from the flaps defined in the meal lid, with a first tab and second tab becoming prominent from the flaps and the first tab defined from the first flap and the second tab defined from the second flap S320.

The method 200 can be used to quickly assembling and delivering meals by a driver, and can further function for providing an optimal curb side on demand food delivery experience from a consumer point of view. The method 200 is preferably implemented using an embodiment of the apparatus 100 described in Section 1 above.

Block S210 recites: Folding a meal container defining a first interior cavity and a second interior cavity, and functions to assemble the meal container, which is the structural base of the apparatus 100 that carries the food pods and supports the meal lid. The assembling of the meal container creates a tray for the consumption of the meal directly from it without the need of removing the food pods from the meal container. This last use helps in saving space for the consumer during the consumption of the meal.

Block S220 recites: Folding a meal lid mating with the meal container, the meal lid defines at least two lid openings, and functions to close the meal container once placed onto it, to secure the food pods and to remove the food lids once it is removed from the meal container.

Block S230 recites: Inserting the first food pod with the first food lid into the first interior cavity of the meal container, and functions to hold the food pod in a fixed position inside the meal container.

Block S240 recites: Inserting the second food pod with the second food lid into the second interior cavity of the meal container, and functions the same way as Block S230.

Block S250 recites: Placing the meal lid onto the meal container, and functions to close the meal container once placed onto it, to secure the food pods and to remove the food lids once it is removed from the meal container.

Block S260 recites: Mating the food lids by their defined protrusion to the lid openings of the meal lid, and functions to automatically remove the food lids from the food pods when the meal lid is removed from the meal container.

Block S270 recites: Engaging the meal lid to the food lids and such that when the meal lid is subsequently removed from the meal container, the food lids are automatically removed from the food pods, and functions to facilitate the removal of all the food lids from the food pods so that the consumer does not have to be opening or removing each one of the food lids from each one of the food pods.

Block S280 recites: delivering the meal to the consumer, and functions to complete the assembling and delivery preferably by the driver but may be alternatively provided by a restaurant or meal provider. Block S280 can additionally or alternatively comprise the driver carrying the food pods, the food lids, the meal container, the meal lid inside the car and which functions for carrying all the elements necessary for assembling and delivering a meal before an order is made by the consumer. Block S280 can additionally or alternatively comprise the order made by the consumer and further accepted by the driver which functions as a trigger for starting method 200. The order is made preferably through a software application in a smart phone but it may be alternatively be made by phone call or internet web page. Block S280 can additionally or alternatively comprise the driver driving to the consumer's location and the driver assembling the meal according to the consumer's order, and functions to complete the assembling and delivery based on the information provided by the consumer to the driver preferably through a software application in a smart phone but it may be alternatively be made by phone call or internet web page. Finally, Block S280 can additionally or alternatively comprise the driver handling the assembled meal to the consumer to finally complete the method 200.

Block S290 recites: placing a first food lid unto a first food pod, wherein the first food lid corresponds to the first food pod, and functions to close or seal the food pod so that the food contained in the food pod is not spilled during the assembling and delivery; is not in contact with external environment, conditions or objects; to keep the temperature of the food contained in the food pod; and to engage with the lid openings of the meal lid by their protrusion so when the meal lid is subsequently removed from the meal container, it automatically removes the food lid from the food pod.

Block S300 recites: placing a second food lid unto a second food pod, wherein the second food lid corresponds to the second food pod, and functions the same way as Block S290.

Block S310 recites: pushing two flaps defined in the meal lid, the first flap defined at one side of the meal lid and the second flap defined at an opposite side of the first flap in the meal lid to further defining a first and second hook to aid in the engaging with the meal container, and functions to engage with the sides of the meal container for mating and further securing the meal lid to the meal container.

Block S320 recites: pulling out two tabs from the flaps defined in the meal lid, with a first tab and second tab becoming prominent from the flaps and the first tab defined from the first flap and the second tab defined from the second flap, and functions as a removing or disengaging mechanism of the hooks formed from the flaps engaged to the sides of the meal container; of the meal lid from the meal container; and the food lids from the food pods previously inserted in the meal container.

As a person skilled in the art of will recognize from the previous detailed description and from the figures and claims, modifications and changes can be made to the preferred embodiments of the invention without departing from the scope of this invention defined in the following claims.

What is claimed is:

1. An apparatus for quickly assembling and delivering meals by a driver, comprising:
a meal container defining a first interior cavity and a second interior cavity;
a meal lid mating with the meal container, the meal lid defines at least two lid openings;
a first food pod corresponding to the first interior cavity of the meal container and a first food lid corresponding to the first food pod;
a second food pod corresponding to the second interior cavity of the meal container and a second food lid corresponding to the second food pod;
wherein the first food lid and the second food lid each define a protrusion that mates with one of the lid openings of the meal lid such that when (a) the food lids are placed onto the food pods, (b) the food pods inserted into the meal container, and (c) the meal lid is placed onto the meal container, the meal lid engages the food lids and such that when the meal lid is subsequently removed from the meal container, the food lids are automatically removed from the food pods.

2. The apparatus of claim 1, wherein the meal container has a shape of a rectangle.

3. The apparatus of claim 1, wherein the interior cavities of the meal container have a shape of a cube.

4. The apparatus of claim 1, wherein the meal lid has a shape of a rectangle.

5. The apparatus of claim 1 wherein the lid openings of the meal lid have a shape selected from the group consisting of a square, rectangle, circle, triangle, and combinations thereof.

6. The apparatus of claim 1, further comprising:
Two flaps defined in the meal lid, the first flap defined at one side of the meal lid and the second flap defined at an opposite side of the first flap in the meal lid;
Two tabs defined in the flaps of the meal lid, with a first tab defined from the first flap and a second tab defined from the second flap.

7. The apparatus of claim 6, wherein the first flap and the second flap are inwards when pushed to the meal lid for further defining a first and second hook, and wherein the first tab and the second tab are prominent when pulled out from the flaps.

8. The apparatus of claim 7, wherein the meal lid and the meal container are mating by the first and second hook engaged into the sides of the meal container when the food pods with the food lids placed onto them are inserted into the meal container.

9. The apparatus of claim 8, wherein the food lids are automatically removed from the food pods when the meal lid engaged to the food lids is subsequently removed from the meal container by the tabs of the meal lid being pulled from the meal container and the first and second hook automatically disengaged from the sides of the meal container.

10. The apparatus of claim 1 wherein the material of the meal container, the meal lid and food pods is selected from the group consisting of F-Flute corrugate, corrugated cardboard, corrugated fiberboard, corrugated paper, paper fiber, solid bleach board, paper board, bagasse and a combination thereof; and the material of the food lids is selected from the group consisting of polypropylene, Polystyrene, Polyvinyl Chloride, recycled polyethylene terephthalate, polylactic acid and other rigid polymers.

11. A method for quickly assembling and delivering meals by a driver, comprising:
Folding a meal container defining a first interior cavity and a second interior cavity;
Folding a meal lid mating with the meal container, the meal lid defines at least two lid openings;
Inserting a first food pod with a first food lid into the first interior cavity of the meal container;
Inserting a second food pod with a second food lid into the second interior cavity of the meal container;
Placing the meal lid onto the meal container;
Mating the food lids by their defined protrusion to the lid openings of the meal lid;
Engaging the meal lid to the food lids and such that when the meal lid is subsequently removed from the meal container, the food lids are automatically removed from the food pods;
Delivering the meal to the consumer.

12. The method of claim ii, further comprising:
Placing the first food lid unto the first food pod, wherein the first food lid corresponds to the first food pod;
Placing the second food lid unto the second food pod, wherein the second food lid corresponds to the second food pod;

13. The method of claim 11, further comprising:
Pushing two flaps defined in the meal lid, the first flap defined at one side of the meal lid and the second flap defined at an opposite side of the first flap in the meal lid, to further defining a first and second hook to aid in the engaging with the meal container;
Pulling out two tabs from the flaps defined in the meal lid, with a first tab and second tab becoming prominent from the flaps and the first tab defined from the first flap and the second tab defined from the second flap.

14. The method of claim 13, wherein placing the meal lid onto the meal container by engaging the first hook and the second hook to the sides of the meal container, after the food pods with the food lids are inserted into the meal container.

15. The method of claim 14, wherein pulling the tabs of the meal lid from the meal container automatically disengages the first and second hook from the sides of the meal container, automatically removing the food lids from the food pods.

16. The method of claim 11, wherein the delivering the meal to the consumer by the driver carrying the food pods, the food lids, the meal container, the meal lid inside the car.

17. The method of claim 16, wherein delivering the meal to the consumer upon an order made by the consumer and further accepted by the driver.

18. The method of claim 17, wherein delivering the meal to the consumer by the driver driving to the consumer's location.

19. The method of claim 18, wherein delivering the meal to the consumer by the driver assembling the meal inside the car according to the consumer's order.

20. The method of claim 19, wherein delivering the meal to the consumer by the driver handling the assembled meal to the consumer.
